(19) United States
(12) Patent Application Publication
(10) Pub. No.: US 2010/0096062 A1
(43) Pub. Date: Apr. 22, 2010

(54) Supported Article for Use in Decorating a Substrate

(75) Inventors: Ann Marie Lentz, Brookfield, WI (US); Gregory Mathew Canard, West Bend, WI (US); Brian James Brodzeller, Mayville, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Serigraph, Inc., West Bend, WI (US)

(21) Appl. No.: 12/560,898

(22) Filed: Sep. 16, 2009

Related U.S. Application Data
(60) Provisional application No. 61/097,329, filed on Sep. 16, 2008.

(51) Int. Cl. B32B 37/00; B32B 3/10; B05D 1/36; B32B 38/14

(52) U.S. Cl. 156/60; 428/203; 427/259; 156/277

(57) ABSTRACT

Disclosed are printed articles that may be used to decorate substrates.

### CROSS-REFERENCE TO RELATED APPLICATION

This application claims the benefit under 35 U.S.C. §119(e) to U.S. Provisional Application No. 61/097,329, filed on Sep. 16, 2008, the content of which is incorporated herein by reference in its entirety.

### BACKGROUND AND SUMMARY

The field of the invention relates to supported articles that can be used for decorating substrates. In some embodiments, the supported articles include: (a) a support layer comprising a plastic material; (b) a mask layer printed on a top surface of the support layer; (c) a first transparent layer printed on a top surface of the mask layer; (d) a graphic image layer positioned on a top surface of the first transparent layer; and (e) a second transparent layer printed on a top surface of the graphic image layer. The support material typically comprises a plastic material, preferably a low grade plastic material such as high density polyethylene (HDPE) or polyethylene terephthalate (PET). The graphic image layer may be applied by methods that include, but are not limited to, printing, applying gold leafing, and applying hot stamp foil.

The mask layer of the printed article can be peeled away from the support layer, for example by hand, together with the additional layers that are printed on the top surface of the mask layer. The printed article does not require soaking in an aqueous bath in order to remove the support layer (e.g., as in a waterslide construction).

The printed article includes a graphic image layer. In the graphic image layer a graphic image is applied as a mirror image, where an observer, viewing the image from the top perspective of the article, views the mirror image of the graphic image (relative to how the image is displayed after having been applied to a substrate).

The printed article also includes printed first and second transparent layers. The first and second transparent layers comprise ink material having desirable properties after the printed article has been applied to a substrate and heat-cured. For example, after the printed article has been applied to a substrate and cured (e.g., by heat-cured or by curing at room temperature), the ink material of the first transparent layer is releasable from the mask layer. In addition, the printed article has been applied to a substrate and heat-cured the ink material of the second transparent layer adheres to the substrate. The first and second transparent layers may comprise the same or different ink material (preferably the same ink material).

Also disclosed are methods for preparing printed articles. In some embodiments, the methods include: (a) printing a mask layer on a top surface of a support layer; (b) printing a first transparent layer on a top surface of the mask layer; (c) applying a graphic image layer on a top surface of the first transparent layer, wherein the graphic image layer comprises a graphic image that is applied as a mirror image; and (d) printing a second transparent layer on top surface of the graphic image layer. In some embodiments, the mask layer, transparent layers, and graphic image layer may comprise a suitable ink (e.g., a UV-curable ink or a heat-curable ink such as those sold by Polymeric Imaging Incorporated, North Kansas City, Mo. under the trademark “GTR” and may include vinyl-based inks). In other embodiments, the graphic image layer may comprise gold leafing or hot-stamp foil. The afore-described printed articles may be prepared by this disclosed method or any other suitable method.

Also disclosed are methods for attaching a graphic image to a substrate. The methods may include: (a) obtaining a printed article, for example, a printed article as disclosed herein and comprising: (i) a support layer comprising a plastic material; (ii) a mask layer printed on a top surface of the support layer; (iii) a first transparent layer printed on a top surface of the mask layer; (iv) a graphic image layer printed on a top surface of the first transparent layer; and (v) a second transparent layer printed on a top surface of the graphic image layer; (b) removing the support layer from the printed article (e.g., by peeling away by hand the mask layer and the additional layers printed on the top surface of the mask layer); (c) contacting the second transparent layer of the printed article with the substrate; and (d) curing the printed article (e.g., by applying heat to the printed article and/or substrate or by allowing the printed article and substrate to cure at room temperature for approximately twenty-four (24) hours), thereby attaching the graphic image to the substrate. The methods may include removing the mask layer from the printed article (e.g., after heat-curing). Heat-curing may be performed by applying heat at a temperature of about 170-200° F. to the printed article for a suitable period of time (e.g., 8-10 minutes).

Suitable substrates to which the article may be applied include a variety of porous and non-porous substrates. Suitable substrates may include solid substrates having flat or curved top surfaces. Suitable substrates may include metal objects which optionally may be primed or painted before applying the printed article. Other suitable substrates may include plastic objects, wood objects, and textiles.

### BRIEF DESCRIPTION OF THE DRAWINGS

FIG. 1 displays a printed article of the prior art.

FIG. 2 illustrates a method of the prior art for applying the printed article of FIG. 1 to a solid substrate.

FIG. 3 illustrates one embodiment of a printed article as contemplated herein.

FIG. 4 illustrates a method for applying the printed article of FIG. 3 to a solid substrate.

FIG. 5 illustrates a preferred embodiment of a printed article as contemplated herein.

FIG. 6 illustrates a method for applying the printed article of FIG. 5 to a solid substrate.

### DETAILED DESCRIPTION

Disclosed are printed articles that can be used for decorating substrates.

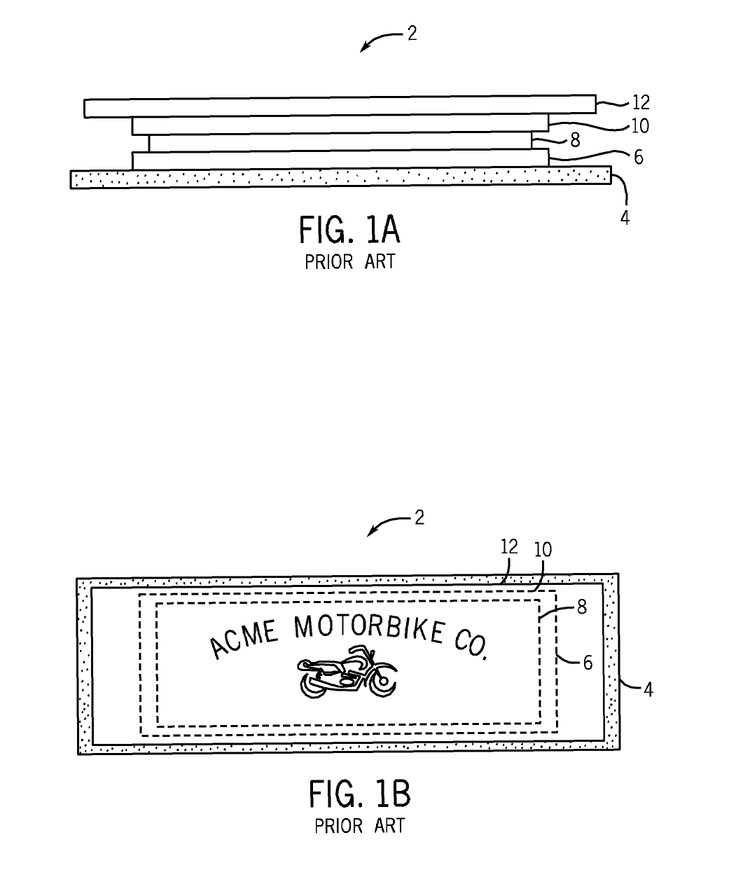

FIG. 1 shows a printed article of the prior art 2. FIG. 1A provides a side perspective view of the article and FIG. 1B provides a top perspective view of the article. The article includes a support layer 4 comprising paper or cellulose. Printed on the top surface of the support layer is a first transparent layer 6. Printed on the top surface of the first transparent layer is a graphic image layer 8 having a graphic image that is face-up from a top perspective view. Printed on the top surface of the graphic image layer is a second transparent layer 10. Printed on the top surface of the second transparent layer is a mask layer 12.

In contrast to the printed articles disclosed herein, the support layer 4 of the printed article of FIG. 1 comprising paper or cellulose cannot be peeled from the printed article when the printed article is in dry form. Rather, the support layer is removed in what is commonly referred to as a “waterslide” process in which the printed article is wetted and adhesive bonds between the support layer 4 and the first transparent layer 6 are broken. This facilitates removal or sliding of the support layer 4 from the first transparent layer 6, the graphic image layer 8, the second transparent layer 10, and the mask layer 12, which remain adhered to each other after wetting.

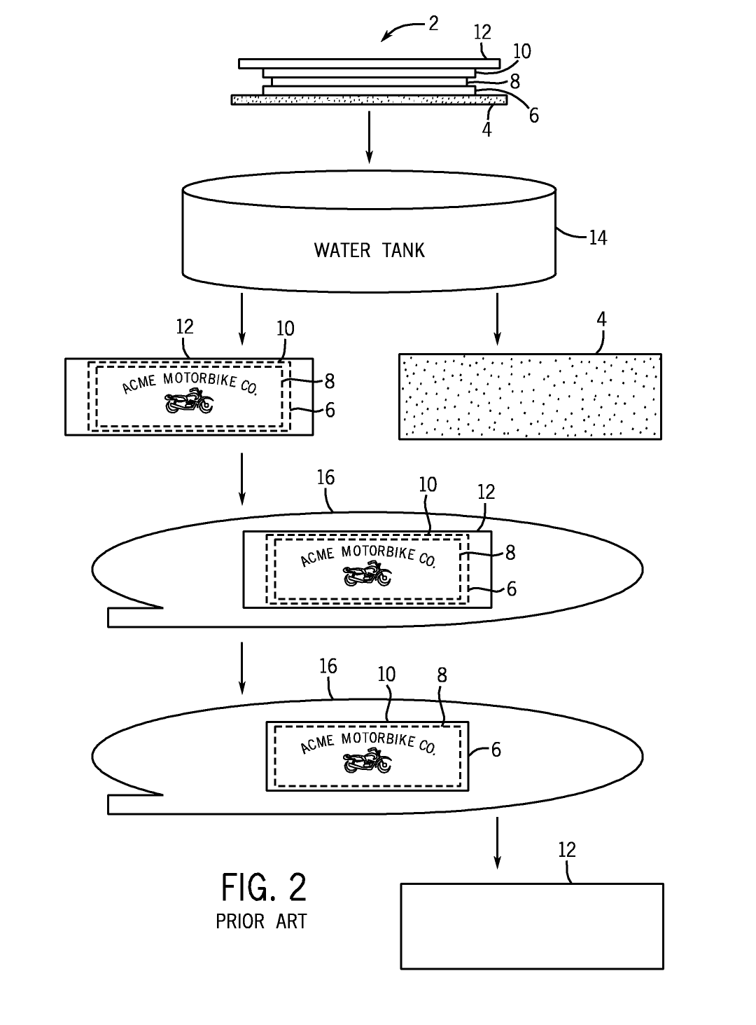

FIG. 2 schematically illustrates a method for applying the printed article of FIG. 1 to a solid substrate. The printed article 2 is placed into a water tank 14 and the printed article is wetted. In particular, the support layer 4 is wetted and adhesive bonds between the support layer 4 and the first transparent layer 6 are broken. The support layer 4 is removed from the other layers (namely the first transparent layer 6, the graphic image layer 8, the second transparent layer 10, and the mask layer 12 which remain adhered to each other). After the support layer 4 has been removed, the printed article is applied face-up to a solid substrate 16 such that the first transparent layer 6 contacts a top surface of the solid substrate. The printed article then is heat-cured. The ink of the first transparent layer adheres to the solid substrate and the graphic image becomes attached. The mask layer 12 may be removed and discarded after heat-curing and cooling.

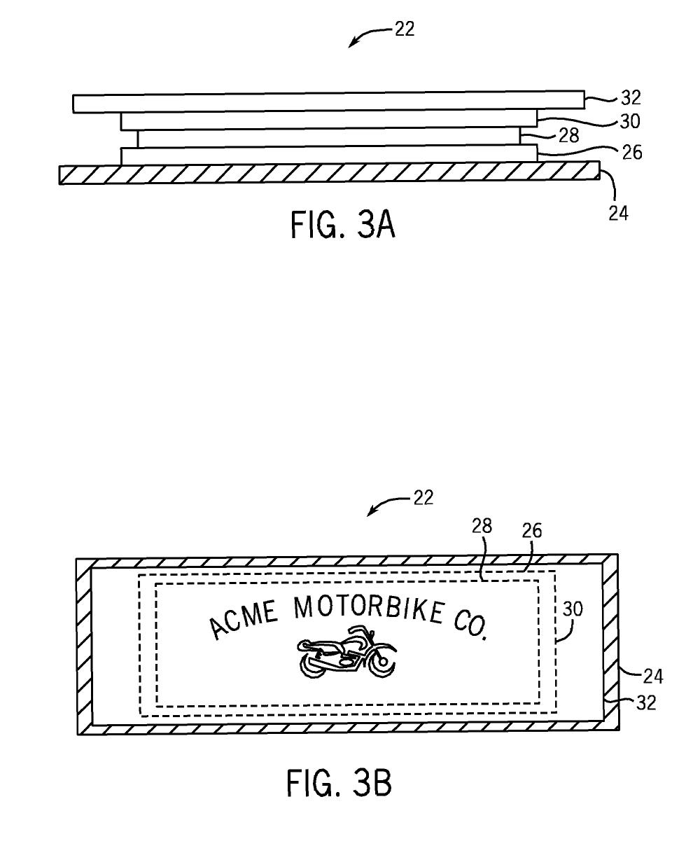

Because the prior art methods for applying printed articles to a solid substrate required the use of a water tank in a waterslide process, a printed article was devised in which the support layer can be peeled away by hand from the other layers (namely the first transparent layer, the graphic image layer, the second transparent layer, and the mask layer) without the need for a water tank. In particular, a printed article having a plastic support layer was devised. FIG. 3 shows one embodiment of a printed article 22 as contemplated herein. FIG. 3A provides a side perspective view of the article and FIG. 3B provides a top perspective view of the article. The article includes a support layer 24 comprising a plastic material as understood in the art. Printed on the top surface of the support layer is a first transparent layer 26. Printed on the top surface of the first transparent layer is a graphic image layer 28 having a graphic image that is face-up from a top perspective view. Printed on the top surface of the graphic image layer is a second transparent layer 30. Printed on the top surface of the graphic image layer is a mask layer 32.

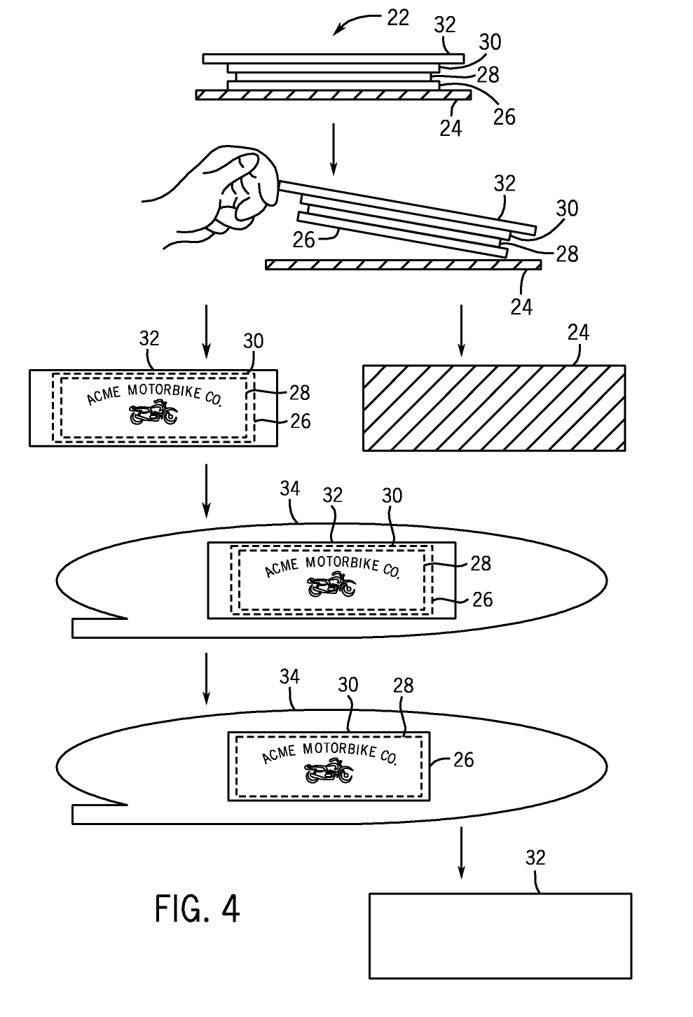

FIG. 4 schematically illustrates a method for applying the printed article of FIG. 3 to a solid substrate. The mask layer 32 is peeled away from the support layer 24 by hand. The first transparent layer 26, the graphic image layer 28, and the second transparent layer 30, are adhered to the mask layer 32 and the support layer is removed from the printed article 22 and may be discarded or recycled in a method for preparing another printed article. After the support layer 24 has been removed from the printed article, the remaining layers (namely the first transparent layer 26, the graphic image layer 28, the second transparent layer 30, and the mask layer 32) are flexible and can smoothly contact a substrate having a curved top surface. The printed article 22, having had the support layer 24 removed, then is contacted with a top surface of a solid substrate 34 for decoration such that the first transparent layer 26 directly contacts the top surface of the solid substrate 34. The printed article then is heat-cured. The ink of the first transparent layer 26 adheres to the solid substrate 34 and the graphic image becomes attached. The mask layer 32 may be peeled away from the second transparent layer 20 after heat-curing and cooling.

In the course of preparing and utilizing the printed article of FIG. 3, it was observed that the first transparent layer 26 did not always release from the support layer 24 after peeling by hand. Portions of the first transparent layer 26 would tear and remain adhered to the support layer 24 after the mask layer 32 was peeled from the support layer 24.

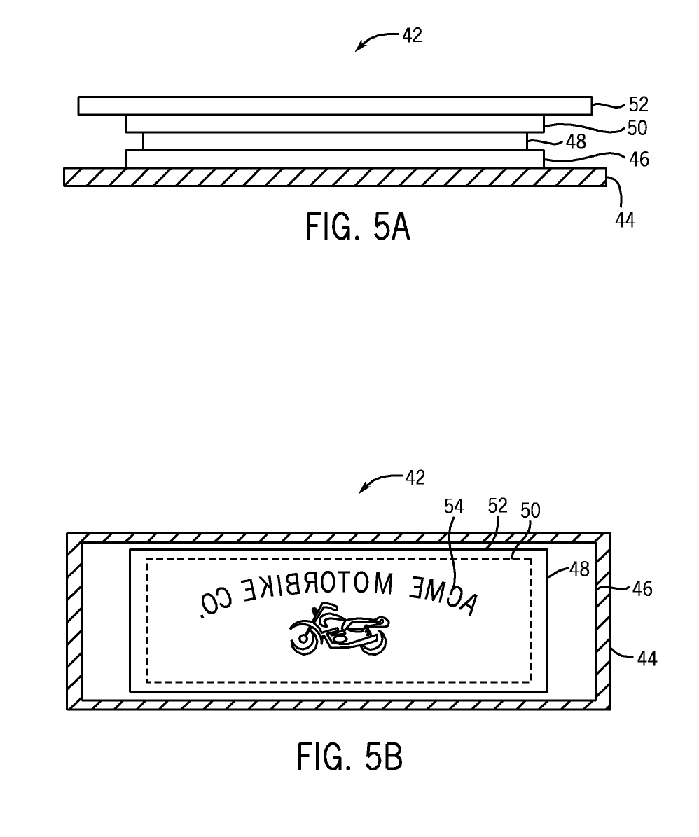

Another embodiment of a printed article 42 was devised having the configuration illustrated in FIG. 5. The printed article illustrated in FIG. 5 essentially reverses the order of the layers printed on the support layer 44 relative to the order of the layers printed on the support layer 24 in printed article 22 of FIG. 3. FIG. 5A provides a side perspective view of the article and FIG. 5B provides a top perspective view of the article. The article includes a support layer 44 comprising a plastic material as understood in the art. Printed on the top surface of the support layer is a mask layer 46. Printed on the top surface of the mask layer is a first transparent layer 48. Printed on the top surface of the first transparent layer is a graphic image layer 50 having a graphic image 54 that is face-down from a top perspective view (i.e., providing a mirror image when viewed from a top perspective). Printed on the top surface of the graphic image layer is a second transparent layer 52. In contrast to the printed article 22 of FIG. 3, the mask layer 46 was observed to be easily peeled from the support layer 44 without tearing and leaving portions of the mask layer 46 adhered to the support layer 24, whereas the first transparent layer 26 of the printed article 22 of FIG. 3 would tear and remain adhered to the support layer 24 after peeling by hand.

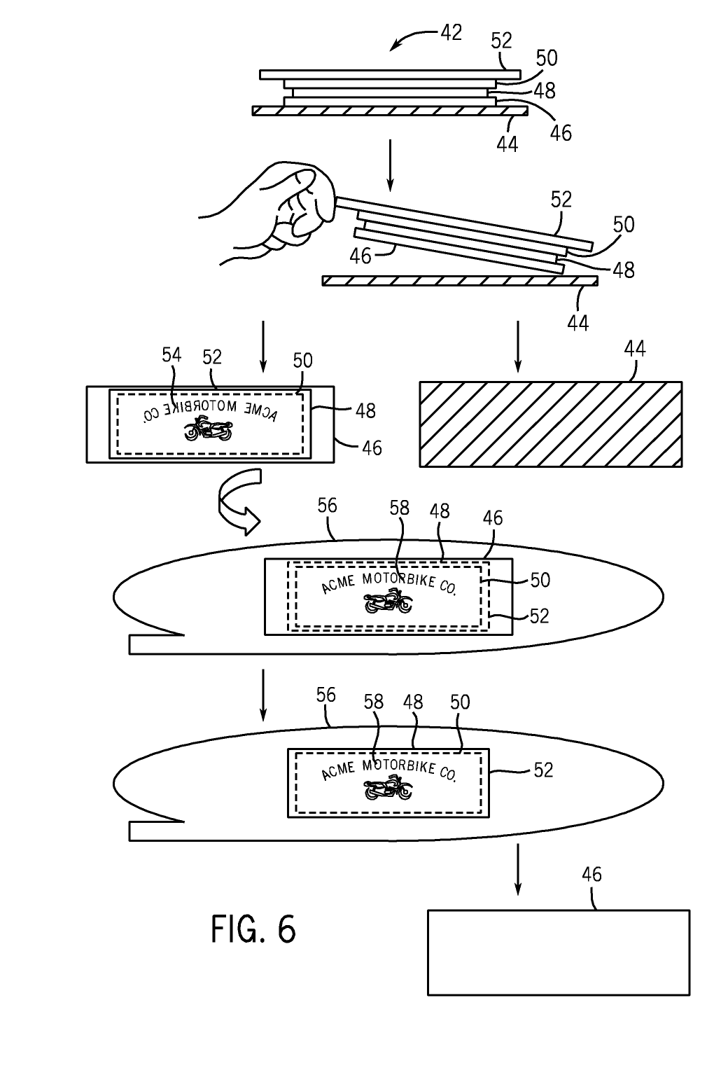

FIG. 6 schematically illustrates a method for applying the printed article of FIG. 5 to a solid substrate 56. The mask layer 46 is peeled away from the support layer 44 by hand. The first transparent layer 48, the graphic image layer 50, and the second transparent layer 52, are adhered to the bottom face of the mask layer 46, and the support layer 44 is removed from the printed article 42 and may be discarded or recycled in a method for preparing another printed article. After the support layer 44 has been removed from the printed article, the remaining layers (namely the mask layer 46, the first transparent layer 48, the graphic image layer 50, and the second transparent layer 52) are flexible and can smoothly contact a substrate having a curved top surface. The printed article 42, having had the support layer 44 removed, then is flipped upside down and contacted with a top surface of a solid substrate 56 for decoration such that the second transparent layer 52 directly contacts the top surface of the solid substrate 56. Prior to contacting, the second transparent layer 52, the top surface of the solid substrate 56, or both the second transparent layer 52 and the top surface of the solid substrate 56 may be misted with a solution comprising water, a soap/water mixture, or an isopropyl alcohol/water mixture to aid in repositioning the remaining layers of the printed article on the substrate. The misting solution may be removed, e.g., by performing a squeegee action. The printed article then is heat-cured. The printed article then is heat-cured. The ink of the second transparent layer 52 adheres to the solid substrate 56 and the graphic image becomes attached. The mask layer 46 may be peeled away from the first transparent layer 48 after heat-curing and cooling. The printed article then is heat-cured. The ink of the second transparent layer 52 adheres to the solid substrate 56 and the graphic image becomes attached. The mask layer 46 may be peeled away from the first transparent layer 48 after heat-curing and cooling.

The disclosed articles are advantageous over printed articles of the prior art for numerous reasons. The disclosed articles provide a user with a low profile graphic article having a small thickness, which may mimic the look of custom painting. In some embodiments, the first transparent layer, the graphic image layer, and the second transparent layer of the printed article, together have a thickness of no more than about 100 microns (preferably no more than about 50 microns, or even more preferably no more than about 25 microns).

The disclosed articles also are useful in methods for decorating solid substrates because the articles do not require soaking in a water bath in order to remove the support layer, as is commonly performed in waterslide methods. As such, applying the printed article to a substrate is easier and does not generate liquid waste materials (i.e., the contaminated water bath utilized for soaking printed articles of the prior art).

The disclosed articles utilize a support layer comprising plastic material, in contrast to printed articles of the prior art which utilize a support layer comprising a paper or cellulose material. For example, the disclosed articles may utilize low grade plastics such as high density polyethylene (HDPE) or polyethylene perephthalate (PET), which can be recycled and are more stable and reproducible with respect to dimension. In addition, printing on plastic as opposed to paper or cellulose is advantageous because it permits the use of inks that can be cured with heat rather than air drying at ambient temperatures. Because heat-curing takes less time than air drying, the disclosed articles can be prepared more quickly than the printed articles of the prior art. Support layers as disclosed herein (otherwise referred to as “waterslide support layers”) typically are plastic and are advantageous over waterslide support layers of the prior art. Waterslide support layers of the prior art usually consist of coated paper. Printing and cutting of paper support layers contributes to fiber contaminates with the printing and graphic layer application process.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems and method steps described herein may be used alone or in combination with other configurations, systems and method steps. It is to be expected that various equivalents, alternatives and modifications are possible. The afore-cited patents and published applications are incorporated herein by reference in their entireties.

What is claimed is:

1. A printed article comprising:
(a) a support layer comprising a plastic material;
(b) a mask layer printed on a top surface of the support layer;
(c) a first transparent layer printed on a top surface of the mask layer;
(d) a graphic image layer applied on a top surface of the first transparent layer; and
(e) a second transparent layer printed on a top surface of the graphic image layer.

2. The printed article of claim 1, wherein the plastic material is a low grade plastic material comprising high density polyethylene (HDPE) or polyethylene perephthalate (PET).

3. The printed article of claim 1, wherein the mask layer can be peeled from the support layer.

4. The printed article of claim 1, wherein the graphic image layer comprises a graphic image that is a mirror image viewed from a top perspective.

5. The printed article of claim 1, wherein the second transparent layer comprises an ink material that adheres to a solid substrate after heat-curing.

6. The printed article of claim 1, wherein the first transparent layer comprises an ink material that is releasable from the mask layer after heat-curing.

7. The printed article of claim 1, wherein the first transparent layer and the second transparent layer comprise the same ink material.

8. The printed article of claim 1, wherein the first transparent layer and the second transparent layer comprise different ink material.

9. The printed article of claim 1, wherein the graphic image layer is printed on the top surface of the first transparent layer.

10. The printed article of claim 1, wherein the graphic image layer is applied as gold leafing on the top surface of the first transparent layer.

11. The printed article of claim 1, wherein the graphic image layer is applied as hot-stamp foil on the top surface of the first transparent layer.

12. A method for preparing a printed article, the method comprising:
(a) printing a mask layer on a top surface of a support layer;
(b) printing a first transparent layer on a top surface of the mask layer;
(c) applying a graphic image layer on a top surface of the first transparent layer, wherein the graphic image layer comprises a graphic image that is applied as a mirror image; and
(d) printing a second transparent layer on top surface of the graphic image layer.

13. The method of claim 12, wherein the graphic image layer is applied by printing a UV-curable ink or a heat-curable ink.

14. The method of claim 12, wherein the graphic image layer is applied as gold leafing.

15. The method of claim 12, wherein the graphic image layer is applied as hot-stamp foil.

16. A method for attaching a graphic image to a substrate, the method comprising:
(a) obtaining a printed article, the printed article comprising:
(i) a support layer comprising a plastic material;
(ii) a mask layer printed on a top surface of the support layer;
(iii) a first transparent layer printed on a top surface of the mask layer;
(iv) a graphic image layer applied on a top surface of the first transparent layer; and
(v) a second transparent layer printed on a top surface of the graphic image layer;
(b) removing the support layer from the printed article;
(c) contacting the second transparent layer of the printed article with the substrate; and
(d) curing the printed article, thereby attaching the graphic image to the substrate.

17. The method of claim 16, further comprising misting the second transparent layer, misting the substrate, or misting both the second transparent layer and the substrate between steps (b) and (c).

18. The method of claim 16, wherein the graphic image layer comprises a printed graphic image.

19. The method of claim 16, wherein the graphic image layer comprises a gold leaf image.

20. The method of claim 16, wherein the graphic image layer comprises a hot stamp foil image.
